(19) United States
(12) Patent Application Publication
(10) Pub. No.: US 2012/0322331 A1
(43) Pub. Date: Dec. 20, 2012

(54) MULTIFUNCTIONAL MAT AND METHOD OF MANUFACTURE

(75) Inventors: Chris E. Worthington, St. Paul, MN (US); Andrew J. Thoen, Harris, MN (US); Guangda Shi, Woodbury, MN (US); Christopher P. Hakanson, Woodbury, MN (US)

(73) Assignee: CONWED PLASTICS LLC, Minneapolis, MN (US)

(21) Appl. No.: 13/159,964

(22) Filed: Jun. 14, 2011

(51) Int. Cl. B32B 5/26; D04H 3/16

(52) U.S. Cl. 442/381; 156/167

(57) ABSTRACT

In at least one embodiment, a multifunctional mat is provided comprising an interconnected network including a plurality of coextruded integrally joined strands forming a netting and a film bonded to the netting. The coextruded strands have at least three layers having three different compositions. The netting has an average kinetic coefficient ranging from 0.006 to 2.4 when measured according to ASTM D-1894 and a minimum absolute difference in adhesion temperature between the second thermoplastic composition and the other two thermoplastic compositions ranges from 10° C. to 120° C.

### TECHNICAL FIELD

One or more embodiments are related to a multifunctional mat and a method of manufacture of same.

### BACKGROUND

Temporary non-skid surfaces may be provided by use of a mat. An example of such a mat is a grocery shelf liner. Another example is a household shelf liner. Previously, non-skid surfaces were typically semi-permanent having an adhesive backing surface. In more recent instances, the adhesive backing has been replaced by a high friction surface made using a polyvinylchloride (PVC) coated scrim on a polyester fabric. These mats may also desirably have a surface devoid of openings to enable the mat to retain fluids. This retention function allows the fluids to be readily wiped up as well as prevents the fluids from draining on to shelves, drawers and products positioned below the shelf with the mat.

In certain applications, having a multifunctional mat or shelf liner which does not rely upon PVC for the non-skid surface is advantageous. Among the advantages are avoiding discrepancies with product performance demands in the marketplace. An example of the marketplace discrepancies includes having a plasticizer in the PVC which renders the mat flexible enough to drape sufficiently over articles and surfaces. But, the plasticizer may bloom to the surface and interact with urethane and lacquered finishes typical of shelving. The interaction often results in the shelving finish being unacceptably stripped off when the mat is removed. A further example of the marketplace discrepancies is that the polyester fabric with PVC scrim is not readily recyclable because mixed thermoplastic and thermoset materials are present.

Replacing flexible PVC mats and shelf liners with an economical, multifunctional extruded mat having similar features and benefits is difficult without using plasticizers, especially in regards to drapeability and compressibility of the surface to conform to articles placed on the mat. A multifunctional extruded mat has an unbalanced schedule of materials which can make the extrusion processing difficult. An example of extrusion processing difficulties include coextruding multiple materials processed using substantially different and thermally communicative melt temperature zones and divergent melt flow rates within an extrusion die. The resulting extruded mats may result in mats having asymmetric layer structures which yield an undesirable shape, an adhesion failure between layers, or a warped mat due to different shrinkage rates between the layers of different materials.

### SUMMARY

At least one embodiment includes a multifunctional mat comprising an interconnected network including a plurality of coextruded strands integrally joined forming a netting. The coextruded strands have a first layer including a first thermoplastic composition, a second layer bonded to the first thermoplastic layer and including a second thermoplastic composition, and a third layer bonded to the second layer, the third layer including a third thermoplastic composition. In at least certain embodiments, a film is bonded to the netting and the first, second and third thermoplastic compositions differ from each other. The netting has a friction angle ranging from 10 degrees to 40 degrees. The minimum absolute difference in adhesion temperature between the second thermoplastic composition and the first or third thermoplastic compositions ranges from 10° C. to 120° C.

Another embodiment of a multifunctional mat is provided. In this embodiment, the mat comprises an interconnected network that forms a netting including a plurality of coextruded strands. The coextruded strands include a plurality of machine-direction strands defining a machine-direction axis of the netting integrally joined to a plurality of cross-direction strands transverse to the machine-direction strands. The cross-direction strands define a cross-direction axis of the netting transverse to the machine-direction axis of the netting. The netting includes a friction layer having a first thermoplastic composition, a support layer bonded to the friction layer and including a second thermoplastic composition, and an adhesion layer bonded to the support layer and spaced apart from the friction layer and including a third thermoplastic composition. In at least one embodiment, the netting also has a film layer having a fourth plastic composition bonded to the adhesion layer. The drape distance measurement of the mat is different between the machine-direction axis and the cross-direction axis of the netting.

In yet another embodiment, a method of making a multifunctional mat in an extruder having a reciprocating die includes the step of coextruding a plurality of machine-direction strands and a plurality of cross-direction strands. The coextruded strands have a first layer including a first thermoplastic composition have a vinyl-free thermoplastic composition. The coextruded strands also have a second layer bonded to the first layer and including a second thermoplastic composition and a third layer bonded to the second layer and spaced apart from the first layer. The third layer includes a third thermoplastic composition. The method further includes bonding integrally the machine-direction strands with the cross-direction strands in the reciprocating die, when the strands are melted, to form a molten netting. The method also comprises solidifying the molten netting to form the netting. In at least one embodiment, the method also includes bonding a film to the netting. A drape distance of the mat is anisotropic.

### BRIEF DESCRIPTION OF THE DRAWINGS

FIG. 1 is a fragmentary isometric perspective view of a mat according to at least one embodiment;

FIG. 2 is a fragmentary sectional view taken along line 2-2 of FIG. 1;

FIG. 3 is a fragmentary sectional view similar to line 2-2 of FIG. 1 according to another embodiment; and

FIG. 4 is a fragmentary sectional view similar to line 2-2 of FIG. 1 according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where expressly indicated, all numerical quantities in the description and claims, indicated amounts of material or conditions of reaction and/or use are to be understood as modified by the word “about” in describing the broadest scope of the present invention. Practice within the numerical limits stated should be desired and independently embodied. Ranges of numerical limits may be independently selected from data provided in the tables and description. The description of the group or class of materials as suitable for the purpose in connection with the present invention implies that the mixtures of any two or more of the members of the group or classes are suitable. The description of constituents in chemical terms refers to the constituents at the time of addition to any combination specified in the description and does not necessarily preclude chemical interaction among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same techniques previously or later referenced for the same property. Also, unless expressly stated to the contrary, percentage, “parts of,” and ratio values are by weight, and the term “polymer” includes “oligomer,” “copolymer,” “terpolymer,” “pre-polymer,” and the like.

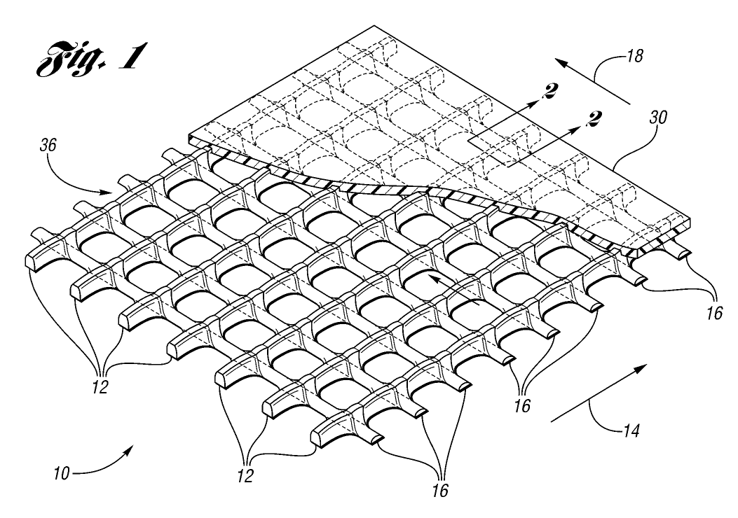

Referring to FIG. 1, a perspective view of an exemplary multifunctional mat 10 is illustrated. While being referred to herein as a “mat”, it should be understood that this term encompasses store mats, as well as consumer shelf liners, non-skid floor coverings, temporary traction strips, and a netting-reinforced substrate among other like structures. Mat 10 includes a netting 36 having strands 12 extending in a machine direction 14 and strands 16 extending in a cross-direction 18. Strands 12 and 16 of netting 36 are bonded to a film 30. While exemplarily illustrated as being bonded to one side of the netting, it should be understood that film 30 could be alternatively bonded the other side of the netting. As depicted in FIG. 1, the cross-direction 18 extends in a generally crosswise or transverse direction relative to the machine direction 14. Although the embodiment depicted in FIG. 1 portrays a substantially square netting configuration, it should be appreciated that other netting configuration shapes such as a rectangle, a rhombus, a trapezoid, a parallelogram, a diamond, or a twill may be used without exceeding the scope or spirit of the embodiment.

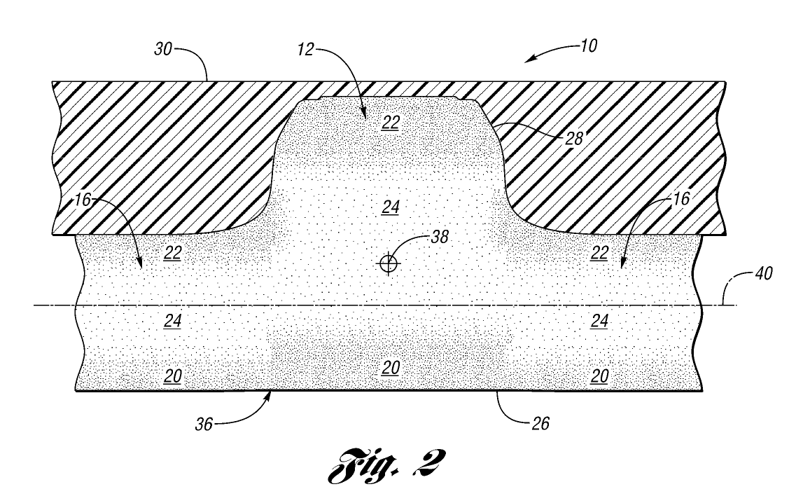

Turning now to FIGS. 2, 3 and 4, certain embodiments of a fragmentary sectional view of mat 10 taken along line 2-2 of FIG. 1 is schematically illustrated. Mat 10 includes netting 36 having a first netting outer layer 20 having a first thermoplastic composition, a netting core layer 24 having a second thermoplastic composition and a second netting outer layer 22 opposed to and spaced apart from the first outer layer 20 having a third thermoplastic composition. Thus, in the illustrated embodiments forming an asymmetric layer structure, the core layer 24 is disposed between the first and second outer layers 20 and 22. In the illustrated embodiment, film 30, having a fourth thermoplastic composition, is thermally bonded in a secondary lamination operation to second netting outer layer 22. In an alternative embodiment, netting 36 could be bonded to the other side, if netting outer layers 20 and 22 are switched. As can be seen, film 30 is spaced apart from netting core layer 24 and first netting outer layer 20. Film 30 provides a layer which may retain spilled fluids and/or other debris. But, the addition of film 30 amplifies the asymmetry of the layer structure by providing an unbalanced, plate-like member situated at a point relatively distant from the neutral axis of mat 10.

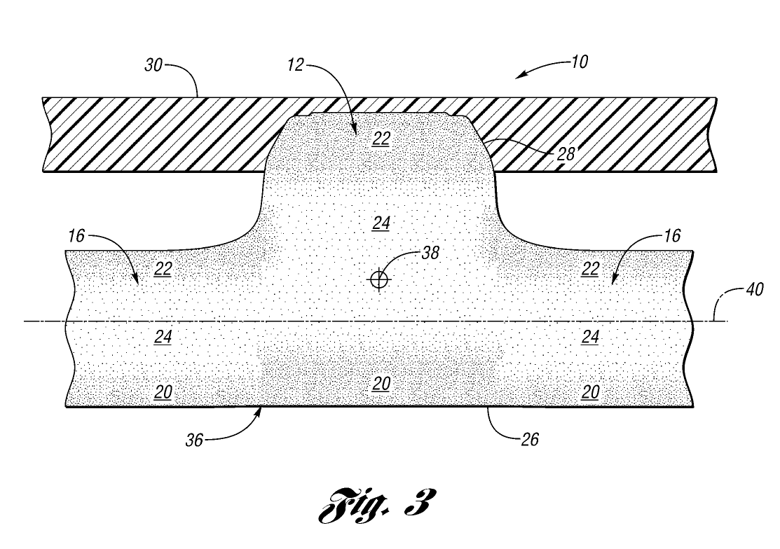

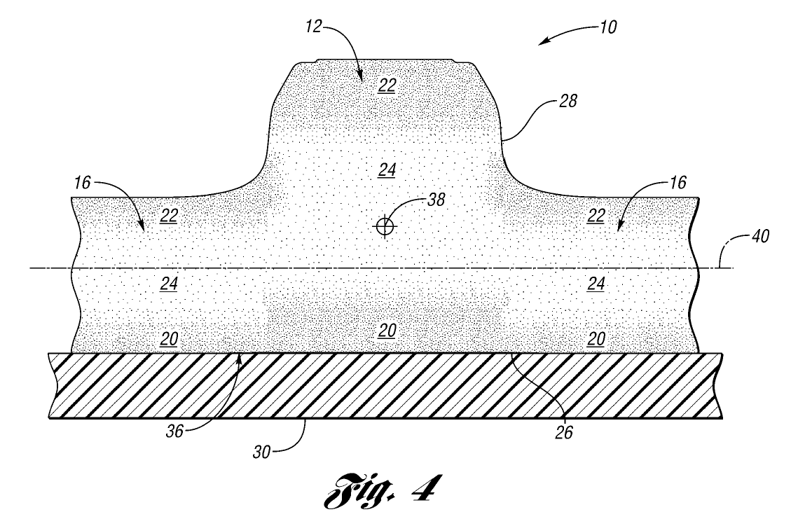

In FIG. 2, film 30 contacts both machine direction strands 12 and cross-direction strands 16. In FIG. 3, film 30 contacts substantially only machine direction strands 12. In FIG. 4, film 30 contacts both machine direction strands 12 and cross-direction strands 16 in an embodiment disclosed below.

Film 30 may be a layer in tension when mat 10 bends during draping. The layer in tension may undesirably reduce the amount of drape. Overcoming the reduction in drape may be surprisingly affected by the extent of connection of film 30 to the netting, by the dimensional structure of strands 12 and 16 of netting 36, and by materials properties of layers 20, 22, and 24, as described in exemplary embodiments below.

Different materials properties provide different functions of mat 10. For example, in at least one embodiment, the first thermoplastic composition of first outer netting layer 20 provides the high-friction surface forming the non-skid surface. In at least certain embodiments, the second thermoplastic composition of netting core layer 24 provides more rigidity and/or stiffness to netting 36 than either first outer netting layer 20 or second outer netting layer 24. The core layer 24, however, is situated about the neutral axis 38 of strands 12 and 16 and thus can have relatively less impact on drape and netting stiffness than the outer layers 20 and 24. However, the impact on drape and netting stiffness increases as the core layer 24 becomes a greater percentage of the thickness of mat 10 relative to the outer layers 20 and 24. Having a relatively stiffer netting core layer 24 also restrains the elongation of the relatively flexible first thermoplastic composition of first outer netting layer 20 aiding in usefulness of the netting 36 during secondary manufacturing operations, such as winding, unwinding, and applying film, and during use by customers.

Improved unwinding of netting 36 is advantageous to secondary operations, such as applying film 30 to netting 36. Restraining first outer netting layer 20 provides relatively improved handling of netting 36 during winding and unwinding of netting 36 when, for example, the shape of the relatively flexible first outer netting layer 20 is restrained and not allowed to stretch out of shape. Netting 36 that retains shape cooperates relatively better when trying to bond film 30 smoothly to netting 36 with minimal distortions and creases.

As an example of the difficulty in providing features and benefits that closely resemble the prior PVC-polyester fabric mats, the tensile modulus of core layer 24 may be balanced between relatively increased flexibility which aids the advantageous drapeability feature of mat 10 and controlling the elongation of netting 36 during handling operations.

Materials in netting 36, in certain embodiments, may be situated in several layers of the asymmetrical layer structure. For example, each of the netting layers 20, 22, and 24 is comprised of polymer resins to form either strand 12 and/or 16. It should be understood that the netting outer layers 20 and 22 form an asymmetrical layer structure when the first, second, and third thermoplastic compositions are different. It should be further understood that strand 12 may have a different composition or the same composition in one or more of netting layers 20, 22, and/or 24 than the composition of the analogous netting layers of strand 16. It should also be understood that while layers are described above in terms indicating distinct layers, in certain embodiments, the boundaries between netting outer layers 20, 22, and/or 24 may be relatively indistinct having one or more transition zones between layers, one or more gradients between layers, and/or mixtures of either the first and second thermoplastic compositions and/or the second and third thermoplastic compositions. It is also understood that the netting outer layers 20 and 24 may be in contact in portions of netting 36 without exceeding the scope or spirit of the embodiments.

In at least one embodiment, the materials in netting 36 and film 30 are a non-ethylenically unsaturated thermoplastic composition. In at least one embodiment, the materials in netting 36 and film 30 are free of polyvinyl chloride (PVC) as detected by infrared spectroscopy. In at least one embodiment, the materials in netting 36 and film 30 are substantially free of PVC. In at least one embodiment, the materials in netting 36 and film 30 are a vinyl-free composition. It should be understood that one or more vinyl groups may be substituents and/or pendant from a polymer backbone, processing aids, and/or contaminants without exceeding the scope and spirit of the materials in netting 36 and film 30 being vinyl-free.

According to one technology, a three-layer netting formed from strands by an extrusion process is provided in U.S. Published Application Numbers 2007/0199654 and 2007/0056899, which are herein incorporated by reference in their entirety. According to one technology, an exit passage of an extrusion die includes reciprocating strikers and raised and spaced lands for forming strands such as strands 12 and 16. For instance, U.S. Pat. Nos. 4,190,692, 4,656,075 and 4,755,247 as well as U.S. Published Application Number 2007/0056899 each provide such a die and methods of use. These patents are herein incorporated by reference in their entirety.

First netting outer layer 20, in at least one embodiment, is formed of the first thermoplastic composition including any suitable polymer resin that is a vinyl-free composition. In another embodiment, the first thermoplastic composition is free of PVC.

An example of the first thermoplastic composition includes an elastomer, such as a block copolymer composition or a block copolymer blend. Non-limiting examples of components of a block copolymer blend may include a thermoplastic elastomer, a di-block copolymer, a star-block copolymer, a cyclic olefin copolymer, a styrene/polyolefin block copolymer, a styrenic di-block copolymer, a styrenic tri-block copolymer, an olefin block copolymer, a dimethylsiloxane olefin block copolymer, natural rubber compounds, and oil-plasticized styrenic block copolymers with a hydrogenated midblock of styrene-ethylene/butylene-styrene (SEBS) or styrene-ethylene/propylene-styrene (SEPS).

In certain embodiments, first netting outer layer 20 is formed of the first thermoplastic composition including a blend of the styrenic tri-block copolymer and the olefin block copolymer. In at least one embodiment, the first thermoplastic composition comprises styrenic block copolymer present in an amount ranging from 45 wt. % to 80 wt. % of the first thermoplastic composition, and olefin block copolymer present in an amount ranging from 20 wt. % to 55 wt. % of the first thermoplastic composition. In another embodiment, the first thermoplastic composition comprises styrenic tri-block copolymer present in an amount ranging from 50 wt. % to 70 wt. % of the first thermoplastic composition, and olefin block copolymer present in an amount ranging from 30 wt. % to 50 wt. % of the first thermoplastic composition.

While the styrenic tri-block copolymer and the olefin block copolymer have been described above as being the primary components of the first thermoplastic composition, it should be understood that any suitable elastomer may be used. Non-limiting examples of suitable other elastomers include, but are not limited to, biopolymer thermoplastic elastomers, co-polyester thermoplastic elastomers, thermoplastic polyurethane (TPU) and thermoplastic vulcanizate (TPV). It should be further understood that while the composition embodiments have been disclosed above for the first thermoplastic composition for use in the first netting outer layer 20, the disclosed first thermoplastic compositions may be suitable for other thermoplastic compositions disclosed for other layers in strands 12 and/or 16, such as the second netting outer layer 22. It should be understood that the first thermoplastic compositions may be formed of virgin or recycled products.

In at least one embodiment, netting 36 has an average kinetic coefficient of sliding, as provided by the first thermoplastic composition, ranging from 0.006 to 2.4 when measured according to ASTM D-1894. In another embodiment, the first thermoplastic composition has the average kinetic coefficient of sliding, as provided by the first thermoplastic composition, ranging from 0.4 to 2. In yet another embodiment, the first thermoplastic composition has the average kinetic coefficient of sliding, as provided by the first thermoplastic composition, ranging from 0.8 to 1.7. The method uses a surface of a stainless steel panel cleaned with acetone or alcohol, assuming no other contaminants are present, such as dust, oil, or water. A 2.5 inch by 8 inch specimen of netting 36 having a 1.5 inch long slit is wrapped around a friction test sled (provided by IMASS Inc., Accord, Mass.). The sled and sample combined weigh 1200 g. The pull rate is 152 mm/min for a distance of 50 mm. The average integral pull force in the region of 5 to 50 mm is determined. A total of at least three specimens are measured. The results are averaged to provide the average kinetic coefficient of sliding.

In certain embodiments, netting core layer 24 provides a dominant portion of the mechanical properties of netting 36 aside from friction. For example, in many embodiments, the tensile modulus of netting core layer 24 dominates the tensile modulus of netting 36 relative to the outer netting layers 20 and 22 as disclosed below. In general, the tensile modulus of netting core layer 24 may be inversely correlated to the tensile elongation at yield of the netting 36 when be stretched by a force. Reducing the tensile elongation at yield of netting 36 reduces stretchiness of netting 36, and thereby improves winding and unwinding behavior of netting 36 because the force needed to unwind mat 10 during secondary operations does not stretch netting 36 beyond the yield point at which netting 36 will not return to shape. This provides a useful substrate for secondary operation; supplying a relatively dimensionally undistorted support layer for film 30 and a finished mat 10 that is relatively regular in shape and unwrinkled compared to a mat prepared with a stretchy support layer.

The mechanical strength of core layer 24 may also be inversely correlated to the drapeability of netting 36 and mat 10. The second thermoplastic composition for the netting core layer 24 may have mechanical properties sufficient to provide support for the thermoplastic compositions of layers 20 and/or 22. But, having sufficient mechanical properties for support relatively lessens the drapeability because of the relative stiffness of the second thermoplastic composition, especially when coupled to the relative dimensional dominance of netting core layer 24 compared to the mechanical properties of the first and third thermoplastic compositions and the thicknesses of outer netting layers 20 and 22.

Netting core layer 24 has, in at least one embodiment, a greater tensile modulus than the relatively high friction thermoplastic composition of layer 20 and the third thermoplastic composition of second outer netting layer 22. In at least one embodiment, the second thermoplastic composition for netting core layer 24 has a tensile modulus which is relatively less than certain netting materials ranging from 13,800 lbf/in² to 35,000 lbf/in² in the machine direction when measured according to ASTM D-882 using the 1% secant measurement method. In another embodiment, the tensile modulus of the second thermoplastic composition for netting core layer 24 ranges from 23,000 lbf/in² to 30,000 lbf/in² in the machine direction.

In certain embodiments, netting core layer 24 also dominates the mechanical properties of netting 36 because layer 24 may be a relatively dominant mass of netting 36, extending portions of netting core layer 24 further from the neutral axis of netting 36. In at least one embodiment, the netting core layer 24 comprises 30 wt. % to 90 wt. % of netting 36. In another embodiment, the netting core layer 24 comprises 50 wt. % to 85 wt. % of netting 36. In yet another embodiment, the netting core layer 24 comprises 60 wt. % to 80 wt. % of netting 36.

The layers 20 and/or 22 may provide the remainder of netting 36. For instance, in at least one embodiment, layers 20 and 22 each comprise 5 wt. % to 35 wt. % of the netting 36. In another embodiment, layers 20 and 22 each comprise 7.5 wt. % to 25 wt. % of the netting 36. In yet another embodiment, layers 20 and 22 each comprise 10 wt. % to 20 wt. % of the netting 36.

The weight ratio of first netting outer layer 20 to second netting outer layer 22 may range from 0.1 to 10 in certain embodiments. In other embodiments, the weight ratio of first netting outer layer 20 to second netting outer layer 22 may range from 0.5 to 5. It is understood that the amount of layer 20 and the amount of layer 22 may be the same or may differ without exceeding the scope and spirit of the embodiment. Such ratios may amplify effects of asymmetric layer structure in embodiments approaching the extreme values or mitigate the asymmetry layer structure effects in embodiments where the ratio approaches 1. It is understood that achieving successful asymmetric layer structures that provide advantageous features and benefits to the netting 36 and mat 10 may be complicated by combinations of the asymmetry of layer thicknesses in addition to the asymmetry of material composition and associated mechanical properties.

In one embodiment, the netting core layer 24 is formed of any suitable polymer resin, such as the second thermoplastic composition. The second thermoplastic composition in netting core layer 24 primarily provides support for the netting outer layers 20 and/or 22. In at least one embodiment, the second thermoplastic composition is a vinyl-free unsaturated thermoplastic composition. In one embodiment, the second thermoplastic composition is substantially free of PVC.

In at least one embodiment, the second thermoplastic composition for the netting core layer 24 includes a matrix material which contributes a predominant component to the mechanical properties of netting core layer 24, such as a polyolefin material. Non-limiting examples of polyolefin material include linear low density polyethylene (LLDPE), low density polyethylene (LDPE), very low density polyethylene (VLDPE), high density polyethylene (HDPE), and polypropylene (PP). The second thermoplastic composition may also include compositions having non-polyolefin materials such as thermoplastic polyurethane (TPU) and nylon; naturally-derived, biodegradable, and/or compostable materials, such as polylactic acid (PLA), polyhydroxybutyrate (PHB), and/or PHB-co-hydroxyvalerate; materials having interpenetrating networks, such as thermoplastic vulcanizates; and long fiber reinforced thermoplastics. It is understood that netting core layer 24 may include polymer blends having networked domains. It should also be understood that the second thermoplastic composition may be formed of virgin or recycled products. The recycled products may include contaminant polymer materials without exceeding the scope or spirit of some embodiments.

In at least one embodiment, the matrix material is present in the second thermoplastic composition in an amount ranging from 30 wt. % to 100 wt. % of the second thermoplastic composition. In another embodiment, the matrix material is present in an amount ranging from 60 wt. % to 80 wt. % of the second thermoplastic composition.

In at least one embodiment, the second thermoplastic composition for the netting core layer 24 includes a block copolymer, such as included in the first thermoplastic composition. In at least one embodiment, the block copolymer is the olefin block copolymer. The olefin block copolymer has relatively lower mechanical properties than the matrix material providing a flexibilizing component to netting core layer 24.

In at least one embodiment, the olefin block copolymer is present in the second thermoplastic composition in an amount ranging from 1 wt. % to 70 wt. % of the second thermoplastic composition. In another embodiment, the olefin block copolymer is present in an amount ranging from 20 wt. % to 40 wt. % of the second thermoplastic composition.

In another embodiment, the second thermoplastic composition optionally includes an inert filler, such as a masterbatch of talc or calcium carbonate on polyethylene. The inert filler may provide increased mechanical stiffness as measured by the tensile modulus. But, the presence of the inert filler reduces the tensile strength of core layer 24 which may improve drapeability. The relatively increased tensile modulus and decreased tensile strength may increase the brittleness of netting 36, such that netting 36 may disadvantageously fracture more readily when draped or when receiving a load from an article placed on the draped surface.

In at least one embodiment, the masterbatch is present in amounts ranging from 1 wt. % to 40 wt. % of the second thermoplastic composition. In another embodiment, the masterbatch is present in amounts ranging from 20 wt. % to 35 wt. % of the second thermoplastic composition. In yet another embodiment, the second thermoplastic composition comprises 70 wt. % LLDPE supplied by Nova® Chemical as FP120A and 30 wt. % olefin block copolymer supplied by Dow® as Infuse® D910710.

As described above, it has been found that forming a coextrusion with an asymmetric layer structure involves relatively closely matching melt flow indices between thermoplastic compositions in layers 20, 22, and 24. Optional inert fillers and the flexibilizing component may have surprising influence on the rheology of the matrix material as measured, in part, by the melt flow index of the matrix material. In one embodiment, the second thermoplastic composition has a melt flow index ranging from 0.75 gms. per 10 minutes to 5 gms per 10 minutes when measured according to ASTM D-1238. In another embodiment, the melt flow index of the second thermoplastic composition ranges from 0.9 gms per 10 minutes to 3 gms per 10 minutes. In another embodiment, the melt flow index of the second thermoplastic composition ranges from 1 gm. per 10 minutes to 2 gms per 10 minutes.

In at least one embodiment, second netting outer layer 22 is formed of the third thermoplastic composition of any suitable polymer resin. In at least one embodiment, the third thermoplastic composition is a vinyl-free thermoplastic composition. In at least one embodiment, the third thermoplastic composition in second netting outer layer 22 is free of PVC. An example of the third thermoplastic composition includes a plastomer. Plastomers are generally produced by single-site catalysts. Non-limiting examples of plastomers include the ExxonMobil® Exact resins, Dow® Affinity resins, and polyolefin-alpha-olefin copolymers. It should be understood that the third thermoplastic composition may be formed of virgin or recycled products. Plastomers have advantageously narrow molecular weight distribution ranges and relatively broad percent crystallinity distributions that enhance mechanical properties in plastomer layers relative to general purpose thermoplastic resins. In certain embodiments, these advantages improve the features and benefits of the netting 36 and mat 10 by narrowing variability in melting temperature and/or adhesion temperature ranges.

In at least one embodiment, the plastomer has the molecular weight distribution index ranging from 1.5 to 5 when measured according to ASTM D-6474. In another embodiment, the plastomer has the molecular weight distribution index ranging from 2 to 3.

An exemplary plastomer is a polyolefin plastomer which may have a matrix of an elastoplastic component. A non-limiting example of the elastoplastic component is an elastoplastic polypropylene having a polyethylene component and a polyolefin elastomer component. The polyolefin plastomer may optionally include a comonomer, the amount of which is inversely correlated to the brittleness of the plastomer. In at least one embodiment, the polyethylene component can be an ethylene homopolymer or an ethylene random copolymer with an octane comonomer or other alpha-olefin comonomers. Suitable alpha-olefin comonomers include, but are not limited to, 1-butene, 1-pentene, 1-hexene, and 4-methyl-1-pentene comonomers. In at least one embodiment, the ethylene random copolymer has an ethylene amount in the range from 80 wt. % of ethylene to 98 wt. % of ethylene. In another embodiment, the ethylene random copolymer has an ethylene amount in the range from 85 wt. % of ethylene to 95 wt. % of ethylene.

In at least one embodiment, the plastomer has from 0.1 wt. % to 40 wt. %, alpha-olefin comonomers. In another embodiment, the plastomer has from 5 wt. % to 25 wt. %, alpha-olefin comonomers.

Isotacticity of polyolefins is known in the art to be positively correlated with stiffness and other mechanical properties as well as percentage crystallization which is correlated with the reduction of variability of melting temperature. Isotacticity is inversely correlated with the breadth of molecular weight distribution, the effects of which are disclosed above. In at least one embodiment, the polyethylene component has an isotacticity index ranging from 80 to 100. In another embodiment, the polyethylene component has an isotacticity index ranging from 85 to 95.

In another embodiment, the polyolefin plastomer includes an ethylene-propylene based rubber and an ethylene-1-butene based rubber. In one embodiment, the ethylene-propylene based rubber includes from 15 wt. % to 85 wt. % of ethylene and from 15 wt. % to 85 wt. % of propylene. In another embodiment, the ethylene-propylene based rubber includes from 18 wt. % to 40 wt. % of ethylene and from 60 wt. % to 82 wt. % of propylene. The ethylene-propylene based rubber can optionally have comonomers. Non-limiting examples of comonomers include 1-butene, 1-pentene, 1-hexene, 4-methyl-1-pentene, 1-octene, butadiene, and isoprene.

In another embodiment, ethylene-1-butene based rubber includes from 60 wt. % to 90 wt. % of ethylene and from 10 wt. % to 40 wt. % of 1-butene, and in other embodiments from 70 wt. % to 85 wt. % of ethylene and from 15 wt. % to 30 wt. % of 1-butene. The ethylene-1-butene based rubber can optionally comprise other comonomers. Non-limiting examples of comonomers include propylene, 1-pentene, 1-hexene, 4-methyl-1-pentene, 1-octene, butadiene, and isoprene.

During profile coextrusion of the asymmetrical layer structure of netting 36, particularly any structure with relatively high elasticity and elongation (e.g., having the second thermoplastic composition with a relatively low tensile modulus and a plastomer with an elastoplastic component), an extrusion melt may develop an unstable melt flow which may result in melt fracture. It has been found that melt flow may be advantageously stabilized during profile coextrusion of the asymmetrical layer structure by matching the ratio of melt flow indices of the adjacent coextruded layers. A non-limiting example of an asymmetrical structure includes a multiple layer coextrusion having at three layers of differing compositions, described as an A/B/C coextrusion structure. In at least one embodiment, the A/B/C coextrusion structure includes having two adjacent layers, B and C layers, where B is the netting core layer 24 and C is the second netting outer layer 22, that have a ratio of the melt indices between two adjacent layers ranging from 1.5 to 5. In another embodiment, the ratio of melt flow indices between A and B layers ranges from 2 to 4. It should be understood that second outer netting layer 22 can be the A layer and the first outer netting layer 20 can be the C layer.

In at least one embodiment, the absolute difference of melt flow indices between the first outer layer 20 or the second netting outer layer 22 and the netting core layer 24 is less than 5 gms per 10 minutes. In at least one embodiment, the absolute difference of melt flow indices between the first outer layers 20 or the second netting outer layer 22 and the core layer ranges between 1 gms and 3 gms per 10 minutes.

In certain embodiments, the asymmetric layer structure is formed by bonding the plastomer of second netting outer layer 22 to the carrier of netting core layer 24 which includes a tie layer (not shown) situated between the netting core layer 24 and second netting outer layer 22. In at least one embodiment, the plastomer of second netting outer layer 22 and netting core layer 24 create a blend in the extrusion die at an interface between the two layers creating in-situ such a tie layer. In another embodiment, the plastomer coextrudes with the carrier without a tie layer. While not wishing to be bound by any one theory, the plastomer may have sufficient practical compatibility with the carrier layer composition that a tie layer is not needed (i.e., where the two matrix components have domain sizes sufficiently small that the domains bond well to each other). Compatibility can be demonstrated by having cohesive failure between layers 22 and 24, when the layers 22 and 24 are peeled apart.

It has been found that in at least one embodiment that the third thermoplastic composition of second netting outer layer 22 provides an unexpectedly good processable blend while forming netting having cohesive failure between second netting outer layer 22 and netting core layer 24. In certain embodiments, failure between second netting outer layer 22 and netting core layer 24 may be a mixed failure including both cohesive and adhesive failure. In at least one embodiment, the fraction of the interface between second netting outer layer 22 and netting core layer 24 experiencing cohesive failure may range from 50% of the interfacial area between the layers to 100% of the interfacial area. In another embodiment, the fraction of the interface between second netting outer layer 22 and netting core layer 24 experiencing cohesive failure may range from 75% of the interfacial area between the layers to 100% of the interfacial area. A non-limiting example of composition having such practical compatibility includes the plastomer having a metallocene polyolefin-alpha olefin composition and the netting core layer 24 having a polyolefin composition.

It is advantageous to have the first netting outer layer 20 be well bonded to the netting core layer 24, and to have the netting core layer 24 well bonded to the second netting outer layer 22. In at least one embodiment, bonding of each of the pairs of layers above occurs by thermal bonding. Thermal bonding occurs when the pair of layers is sufficiently heated to bond together in a molten state, which may include a softened state. The melt temperature of any of the thermoplastic compositions can refer to any temperature wherein the thermoplastic composition begins to melt. It should be appreciated that a mechanical bond can be created between various thermoplastic compositions without the component materials reaching their melt temperature. Indeed, one thermoplastic composition does not necessarily need to melt to adhere to another thermoplastic composition. Instead, the temperature of thermoplastic compositions, in general, may be elevated such that the component materials reach a tackified state, so that adhesion between two thermoplastic compositions may take place. This elevated temperature may be referred to as the adhesion temperature. Advantageously, the first, second, and third thermoplastic compositions may be selected so the first, second, and third thermoplastic compositions have degradation temperatures that are greater than the highest adhesion temperature of the first, second, and third thermoplastic compositions.

Certain plastomers may provide a relatively low melting temperature composition for use in a relatively low adhesion temperature state when laminating the film 30 to the second netting outer layer 22. In at least one embodiment, the relatively low adhesion temperature of the second netting outer layer 22 is less than service temperatures of the first netting outer layer 20 and the netting core layer 24. In another embodiment, the minimum absolute difference between the adhesion temperature of the second netting outer layer 22 and the service temperatures of the first netting outer layer 20 and the netting core layer 24 ranges from 10° C. to 120° C. as measured according to differential scanning calorimetry (DSC) of the service temperatures for relatively crystalline compositions having definable melting points, such as the first netting outer layer 20 or as measured for relatively non-crystalline compositions such as netting core layer 24 having no true melting temperature by Vicat softening temperature according to ASTM D-1525. In another embodiment, the minimum absolute difference in adhesion temperature of the second netting outer layer 22 and the service temperatures of the first netting outer layer 20 and the netting core layer 24 ranges from 40° C. to 100° C.

In at least one embodiment, the tensile elongation at yield of the netting 36 ranges from 1% to 25%, when measured according to ASTM D-1708. In another embodiment, the tensile elongation at yield of the netting 36 ranges from 3% to 15%. In yet another embodiment, the tensile elongation at yield of the netting 36 ranges from 4% to 12%.

In another embodiment, the netting 36 has a tensile strength at break ranging from 5,000 lbf/in² to 12,000 lbf/in² when measured according to ASTM D-412. It should be understood that this tensile strength at break for the netting 36 may be achieved or modified by orienting the strands or the netting either uniaxially or biaxially without exceeding the scope and spirit of the embodiments.

In at least one embodiment, netting 36 has a tensile modulus ranging from 20,000 lbf/in² to 35,000 lbf/in² in the machine direction when measured according to ASTM D-882 using the 1% secant measurement method. In another embodiment, the tensile modulus of the netting 36 ranges from 23,000 lbf/in² to 30,000 lbf/in² in the machine direction.

In at least one embodiment, netting 36 has a flat surface 26 (FIG. 2) that is an externally-facing surface of first netting outer layer 20. A non-flat surface 28 (FIG. 2) is an externally-facing surface of second netting outer layer 22 facing the film 30. The first netting outer layer 20 is formed in an extrusion process in which layer 20 is flattened in the die land and when it exits the die. The first netting outer layer 20 is cooled by passing along a mandrel. Thus, the first netting outer layer 20 is formed to be a relatively flat surface 26 in which the first netting outer layer 20 of strand 12 and the first netting outer layer 20 of strand 16 are substantially co-planar. By contrast, in at least one embodiment, the second netting outer layer 22 is cooled by exposure to a water bath, and therefore has contours typically associated with an integral joint between the machine-direction strand and the cross-direction strand. In at least one embodiment, the second netting outer layer 22 is characterized as the non-flat surface 28 in which a center of mass of the second netting layer 22 of strand 12 and a center of mass of the second netting layer 22 of strand 16 are substantially non-planar. It should be understood that the first netting outer layer 20 may form the non-flat surface 28 and the second netting outer layer 22 may form the flat surface 26 without exceeding the scope and spirit of the embodiments.

In at least one embodiment, the netting 36 has an average thickness ranging from 0.05 inches to 1.2 inches. In another embodiment, the average thickness of the netting 36 ranges from 0.1 inches to 0.6 inches. In yet another embodiment, the average thickness of netting 36 ranges from 0.15 inches to 0.40 inches.

In at least one embodiment, machine-direction strands 12 used in the netting 36 have an average thickness ranging from 0.05 inches to 0.2 inches. In another embodiment, strands used in the netting have average thickness ranging from 0.1 inches to 0.6 inches.

In at least one embodiment, cross-direction strands 16 used in the netting 36 have an average thickness ranging from 0.05 inches to 0.5 inches. In another embodiment, cross-direction strands 16 have an average thickness ranging from 0.1 inches to 0.25 inches. In yet another embodiment, cross-direction strands 16 are thinner than machine-direction strands 12.

One suitable method of making the netting 36 in an extruder having a reciprocating die includes the steps of co-extruding a plurality of machine-direction strands and a plurality of cross-direction strands. The method further comprises bonding integrally the machine-direction strands with the cross-direction strands in the extruder to form a molten netting, which may include a softened netting. The method further includes cooling the netting to form a solid netting. The method further includes winding the solid netting into a roll situating a first netting segment adjacent to a second netting segment.

In a secondary lamination step, film 30 is bonded to second netting outer layer 22 to form the multifunctional mat 10. Film 30 includes the fourth thermoplastic composition having, in at least one embodiment, a service temperature ranging from 25° C. to 170° C. greater than the melting temperature of the third thermoplastic composition of second outer netting layer 22. In another embodiment, film 30 has a service temperature ranging from 30° C. to 100° C. greater than the melting temperature of the third thermoplastic composition of second outer netting layer 22. In another embodiment, film 30 may have a plurality of layers. Non-limiting examples of the layers may include a film printing layer, a film core layer, and/or a film adhesive layer.

In yet another embodiment, film 30 may be an extrusion coated film applied by an extrusion coating process on to the netting instead of the secondary lamination step. It is understood that the extrusion coating film may include a plurality of layers such as an extrusion coating base layer and an extrusion coating adhesive layer.

It should be understood that while bonding of film 30 to netting 36 is disclosed above as thermally bonded, other types of bonding known in the art may be used without exceeding the scope or spirit of the embodiment. An example of another type of bonding may include applying an adhesive layer (not shown) between film 30 and second outer netting layer 22. It should also be understood while film 30 is disclosed, other substrates having substantially thicker and/or relatively weaker or stronger properties may also be reinforced by connection to netting 36.

The fourth thermoplastic composition, in at least one embodiment, is formed of any suitable polymer resin. In at least one embodiment, the fourth plastic composition is free of PVC. In another embodiment, the fourth thermoplastic composition includes a matrix material, such as a polyolefin material. Non-limiting examples of polyolefin include linear low density polyethylene (LLDPE), low density polyethylene (LDPE), very low density polyethylene (VLDPE), high density polyethylene (HDPE), polypropylene (PP). The fourth thermoplastic composition may also include compositions having nylon, polylactic acid, polyhydroxybutyrate, PHB-co-hydroxyvalerate, long fiber thermoplastics. It should be understood that the fourth thermoplastic compositions may be formed of virgin or recycled products.

Film 30, in certain embodiments, is a coextruded film and has a plurality of layers. In at least one embodiment, film 30 includes a first film outer layer 32, a second film outer layer 34, and a film core 36 situated therebetween. In yet another embodiment, film 30 is an oriented film, including a biaxially oriented film. In at least one embodiment, film 30 has a balanced coextrusion material schedule. A non-limiting example of the balanced coextrusion material schedule includes metallocene polyolefin layers on both exterior layers about a conventionally-catalyzed polyolefin, such as a Ziegler-Natta catalyzed linear low density polyethylene (LLDPE). In another embodiment, film 30 has an unbalanced coextrusion material schedule.

In at least one embodiment, an exterior layer of the plurality of layers of film 30 may have a thickness ranging from 0.0005 inches to 0.005 inches. In another embodiment, exterior layer of the plurality of layers of film 30 may have a thickness ranging from 0.00075 inches to 0.002 inches.

In at least one embodiment, film 30 may have a thickness ranging from 0.001 inches to 0.005 inches. In another embodiment, exterior layer of the plurality of layers of film 30 may have a thickness ranging from 0.0015 inches to 0.003 inches.

In at least one embodiment of the method, film 30 is laminated to netting 36 to form mat 10 by passing film 30 and netting 36 together through a series of hot rolls at a temperature sufficient to melt or soften a portion of second netting outer layer 22. In at least one embodiment, the temperature of the portion of the second netting outer layer 22 when in the hot rollers ranges from 45° C. to 150° C. In another embodiment, the temperature of the portion of the second netting outer layer 22 when in the hot rollers ranges from 60° C. to 100° C.

In at least one embodiment, film 30 and netting 36 are thermally laminated at a speed ranging from 10 ft/min to 200 ft/min. In another embodiment, film 30 and netting 36 are thermally laminated at a speed ranging from 40 ft/min to 100 ft/min.

In at least one embodiment, the pressure of the thermal laminating process is less than that needed to substantially decrease the overall thickness of the mat 10.

In at least one embodiment, the mat 10 has an average thickness ranging from 0.05 inches to 1.2 inches. In yet another embodiment, the average thickness of the netting 36 ranges from 0.1 inches to 0.6 inches.

In at least one embodiment, machine-direction strands 12 used in the mat 10 have an average thickness ranging from 0.05 inches to 0.9 inches. In another embodiment, strands used in the netting have average thickness ranging from 0.1 inches to 0.6 inches.

In at least one embodiment, cross-direction strands 16 used in the mat 10 have an average thickness ranging from 0.05 inches to 0.5 inches. In another embodiment, cross-direction strands 16 have an average thickness ranging from 0.1 inches to 0.25 inches. In yet another embodiment, cross-direction strands 16 are thinner than machine-direction strands 12.

In at least one embodiment, pressure of the thermal laminating process is such that the film layer 30 is substantially only bonded to the second netting outer layer 22 present on machine-direction strands 12 of the netting 36 on the non-flat surface 28 as schematically illustrated in FIGS. 2-3. In another embodiment, pressure of the thermal laminating process is such that the film layer 30 is bonded to the second netting outer layer 22 present on both machine-direction strands 12 and the cross-direction strands of the netting 36 on the non-flat surface 28. In certain embodiments, the second netting outer layer 22 could comprise the first thermoplastic composition or the third thermoplastic composition. In certain embodiments, the film 30 is situated on the flat surface 26 as schematically illustrated in FIG. 4. In certain embodiments flat surface 26 is formed of the third thermoplastic composition. In other embodiments, the flat surface 26 is formed of the first thermoplastic composition.

The ability of a mat 10 with film 30 to conform or not to conform to an article that it covers may be advantageous. The ability to conform to the article may be measured by a drape distance. Drape distance is measured on a 3″×8″ netting specimen. The specimen is placed at the edge of a horizontal surface, such as a countertop with squared edges. The specimen is extended beyond the horizontal surface by two inches. The portion of the specimen no longer supported the horizontal surface will generally drape downwards. Using a carpenter's square held flat against the horizontal surface measure the drape distance where the specimen intersects the perpendicular or vertical portion of the square.

In at least one embodiment, the drape distance ranges from 0.25 inches to 2 inches. In another embodiment, the drape distance ranges from 0.5 inches to 1.5 inches. In another embodiment, the drape distance ranges from 0.75 inches to 1.25 inches. In at least one embodiment, the ability to conform to the article, such as corners on a shelf, as measured by a drape distance, is anisotropic. In another embodiment, the drape distance ranges from 0.25 inches to 2 inches only when the machine-direction strands are situated perpendicular to the horizontal surface edge. In certain embodiments, the drape distance ranges from 0.05 inches to 1.25 inch only when the cross-direction strands are situated perpendicular to the horizontal surface edge.

In another embodiment, the drape distance is substantially isotropic, varying less than 0.50 inches when oriented with the machine-direction strands are oriented perpendicular and when the cross-direction strands are oriented perpendicular to the horizontal edge.

In at least one embodiment, increasing the compressibility of layers 20, 22, and/or 24 may include creating a foam with a chemical foaming agent, such as Techmer® PM AAB2009. In at least one embodiment, an endothermic chemical blowing agent in a blowing agent masterbatch is used. In at least one embodiment, the amount of chemical blowing agent ranges from 0.25 wt. % to 5 wt. % of the thermoplastic composition of any of the layers in which it is used. In another embodiment, the amount of chemical blowing agent ranges from 0.5 wt. % to 2 wt. % of the thermoplastic composition of any of the layers in which it is used. It should be understood that while an endothermic chemical foaming agent has been described above, any suitable blowing agent may be used. Non-limiting examples of blowing agents may include an exothermic chemical blowing agent, or a mechanical foaming process such as a direct gas injection foaming process of the thermoplastic composition.

In at least one embodiment, the second thermoplastic composition comprises 36 wt. % LLDPE, 30 wt. % olefin block copolymer, 30 wt. % calcium carbonate master batch supplied by Standridge Color as SCC 37026, and 4 wt. % Techmer PMAAB 2009.

In certain embodiments, other additives may be blended into the thermoplastic compositions including, but not limited to, a colorant pigment, a colorant master batch, a heat stabilizer, a processing aid, a slipping agent, a flame retardant, a functional filler, a reinforcement, a plasticizer, a tackifier, and/or an inert filler. It is further understood, that there may be a plurality of layers and compositions beyond the illustrative coextrusion schedules above, without exceeding the scope or spirit of the embodiment.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A multifunctional mat comprising:
an interconnected network including a plurality of coextruded strands integrally joined forming a netting, the coextruded strands including a first layer including a first thermoplastic composition;
a second layer bonded to the first thermoplastic layer and including a second thermoplastic composition;
a third layer bonded to the second layer and spaced apart from the first layer, the third layer including a third thermoplastic composition; and
a film bonded to the netting, wherein the first, second and third thermoplastic compositions differ from each other, the netting has an average kinetic coefficient ranging from 0.006 to 2.4 when measured according to ASTM D-1894 and a minimum absolute difference in adhesion temperature between the second thermoplastic composition and the first or third thermoplastic compositions ranges from 10° C. to 120° C.

2. The mat of claim 1, wherein the first, second, and third thermoplastic compositions are polyvinyl chloride (PVC)-free compositions.

3. The mat of claim 1, wherein the film is bonded to the third layer.

4. The mat of claim 1, wherein the film is bonded to the first layer.

5. The mat of claim 1, wherein the coextruded strands include a plurality of machine-direction strands situated transverse to a plurality of cross-direction strands, and wherein the film thermally bonds substantially to the machine-direction strands.

6. The mat of claim 5, wherein the netting has a first drape distance ranging from 0.25 inches to 2 inches, when 2 inches of a specimen having the machine-direction strands extending beyond and being oriented perpendicular to a horizontal support surface.

7. The mat of claim 6, wherein the netting has a second drape distance when 2 inches of a specimen having the cross-direction strands extending beyond and being oriented perpendicular to the horizontal support surface, the first drape distance being greater than the second drape distance.

8. The mat of claim 1, wherein the first thermoplastic composition is a blend of a styrenic tri-block copolymer and an olefin block copolymer.

9. The mat of claim 8, wherein the olefin block copolymer is present in an amount ranging from 30 wt. % to 50 wt. % of the first thermoplastic compositions.

10. The mat of claim 8, wherein the styrenic tri-block copolymer is present in an amount ranging from 50 wt. % to 70 wt. % of the first thermoplastic composition.

11. The mat of claim 1, wherein the second thermoplastic composition has a tensile modulus greater than either of the tensile moduli of the first and third thermoplastic compositions.

12. The mat of claim 1, wherein the third thermoplastic composition includes a plastomer.

13. The mat of claim 1, wherein the film is a biaxially oriented film.

14. The mat of claim 1, wherein the first, second, and third thermoplastic compositions have degradation temperatures that are greater than the highest adhesion temperature of the first, second, and second thermoplastic compositions.

15. The mat of claim 1, wherein at least one layer is foamed.

16. A multifunctional mat comprising:
an interconnected network to form a netting including a plurality of coextruded strands including a plurality of machine-direction strands defining a machine-direction axis of the netting integrally joined to a plurality of cross-direction strands transverse to the machine-direction strands defining a cross-direction axis of the netting transverse to the machine-direction axis of the netting, the netting including a friction layer having a first thermoplastic composition, a support layer bonded to the friction layer and including a second thermoplastic composition, an adhesion layer bonded to the support layer and spaced apart from the friction layer and including a third thermoplastic composition, and a film layer having a fourth plastic composition and being bonded to the adhesion layer and spaced apart from the support layer, wherein a drape distance measurement of the mat is different between the machine-direction axis and the cross-direction axis of the netting.

17. The mat of claim 16, wherein the friction layer includes a first thermoplastic composition having at least two types of block copolymers which comprise vinyl-free compositions.

18. The mat of claim 16, the third thermoplastic composition has a molecular weight distribution index ranging from 1.5 to 5 when measured according to ASTM D-6474.

19. The mat of claim 16, wherein the second thermoplastic composition comprises a thermoplastic polyurethane.

20. The mat of claim 16, wherein the film has a service temperature ranging from 25° C.-170° C. greater than the service temperature of the third thermoplastic composition when measured according to ASTM D-1525.

21. The mat of claim 16, wherein the mat has tensile elongation ranging from 1% to 25% when measured according to ASTM D-1708 and the support layer has a tensile modulus ranging from 13,800 lbf/in² to 35,000 lbf/in² in the machine direction when measured according to ASTM D-882.

22. A method of making a multifunctional mat in an extruder having a reciprocating die, the method comprising the steps of:
coextruding a plurality of machine-direction strands and a plurality of cross-direction strands, the coextruded strands having a first layer including a first thermoplastic composition having a vinyl-free thermoplastic composition, a second layer bonded to the first layer and including a second thermoplastic composition, and a third layer bonded to the second layer and spaced apart from the first layer, the third layer including a third thermoplastic composition;
bonding integrally the machine-direction strands with the cross-direction strands in the reciprocating die, when the strands are melted, to form a molten netting;
solidifying the molten netting to form the netting; and
bonding a film on the netting, the film being spaced apart from the second layer, wherein a drape distance of the mat is anisotropic.

23. The method of claim 22, wherein the machine-direction strands are substantially perpendicular to the cross-direction strands such that the netting is configured into a substantially square netting.
